(19) United States
(12) Patent Application Publication
(10) Pub. No.: US 2005/0005125 A1
(43) Pub. Date: Jan. 6, 2005

(54) Apparatus and method for generating and verifying ID-based blind signature by using bilinear parings

(75) Inventors: Fangguo Zhang, Daejeon (KR); Kwangjo Kim, Daejeon (KR); Hyunggi Choi, Daejeon (KR)

Correspondence Address: BACON & THOMAS, PLLC, 625 SLATERS LANE, FOURTH FLOOR, ALEXANDRIA, VA, 22314, US

(73) Assignee: Information and Communications University Educational Foundation, Seoul (KR)

(21) Appl. No.: 10/725,001

(22) Filed: Dec. 2, 2003

(30) Foreign Application Priority Data
Jul. 4, 2003 (KR) 10-2003-0045216

(51) Int. Cl. H04L 9/00

(52) U.S. Cl. 713/176

(57) ABSTRACT

In an apparatus and a method for generating and verifying an identity based blind signature by using bilinear parings, a trust authority generates system parameters and selects a master key. Further, the trust authority generates a private key by using a signer's identity and the master key. The signer computes a commitment and sends the commitment to the user. The user blinds a message and sends the blinded message to the signer. The signer signs the blinded message and sends the signed message to the user. Thereafter, the user unblinds the signed message and then verifies the signature.

### FIELD OF THE INVENTION

The present invention relates to a cryptographic system; and, more particularly, to an apparatus and a method for generating and verifying an identity(ID) based blind signature by using bilinear parings.

### BACKGROUND OF THE INVENTION

In a public key cryptosystem, each user may have two keys, i.e., a private key and a public key. A binding between the public key (PK) and the identity (ID) of a user is obtained via a digital certificate. However, in such a certificate-based public key system, before using the public key of the user, a participant must verify the certificate of the user at first. As a consequence, this system demands a large amount of computing time and storage because it is required to store and verify each user's public key and the corresponding certificate.

In 1984, Shamir (A. Shamir, “Identity-based cryptosystems and signature schemes”, Advances in Cryptology-Crypto 84, LNCS 196, pp.47-53, Springer-Verlag, 1984.) published ID-based encryption and signature schemes to simplify key management procedures in a certificate-based public key setting. Since then, many ID-based encryption schemes and signature schemes have been proposed. The main idea of ID-based cryptosystems is that the identity information of each user works as his/her public key, in other words, the user's public key can be calculated directly from his/her identity rather than being extracted from a certificate issued by a certificate authority (CA).

Therefore, the ID-based public key setting need not perform following processes needed in the certificate-based public key setting: transmission of certificates, verification of certificates and the like. The ID-based public key setting can be an alternative to the certificate-based public key setting, especially when efficient key management and moderate security are required.

The bilinear pairings, namely the Weil pairing and the Tate pairing of algebraic curves, are important tools for research on algebraic geometry. Early applications of the bilinear pairings in cryptography were made to resolve discrete logarithm problems. For example, the MOV (Meneze-Okamoto-Vanstone) attack (using the Weil pairing) and FR(Frey-Ruck) attack (using the Tate pairing) reduce the discrete logarithm problems on certain elliptic or hyperelliptic curves to the discrete logarithm problems in a finite field. Recently, the bilinear pairings have found various applications in cryptography as well.

Specifically, the bilinear parings are basic tools to construct the ID-based cryptographic schemes and many ID-based cryptographic schemes have been proposed by using them. Examples of using the bilinear pairings in ID-based cryptographic schemes include: Boneh-Franklin's ID-based encryption scheme (D. Boneh and M. Franklin, “Identity-based encryption from the Well pairing”, Advances in Cryptology-Crypto 2001, LNCS 2139, pp.213-229, Springer-Verlag, 2001.), Smart's ID-based authentication key agreement protocol (N. P. Smart, “Identity-based authenticated key agreement protocol based on Weil pairing”, Electron. Lett., Vol.38, No.13, pp.630-632, 2002.), and several ID-based signature schemes.

In a public key setting, the user information can be protected by means of a blind signature. The idea of using blind signatures was introduced by Chaum(D. Chaum, “Blind signatures for untraceable payments”, Advances in Cryptology Crypto 82, Plenum, N.Y., pp.199-203, 1983.), whose idea was to provide anonymity of users in such applications as electronic voting and electronic payment systems. A blind signature scheme is an interactive two party protocol between a user and a signer. In contrast to regular signature schemes, the blind signature scheme allows the user to obtain a signature of a message with the signer not knowing the contents of the message. The blind signature scheme plays a central role in constructing anonymous electronic cash systems.

Several ID-based signature schemes based on the bilinear pairings have been developed recently. An ID-based blind signature is attractive since one's public key is simply one's identity. For example, if a bank issues electronic cash with an ID-based blind signature, users and shops need not fetch the bank's public key from a database. They can verify the electronic cash only by the following information: “Name of Country”, “Name of City”, “Name of Bank” and “this year”.

### SUMMARY OF THE INVENTION

It is, therefore, a primary object of the present invention to provide a method and an apparatus for generating and verifying an identity based blind signature by using bilinear parings. The blind signature scheme of the present invention is secure against a generic parallel attack and doesn't depend on the difficulty of ROS-problem.

In accordance with one aspect of the present invention, there is provided

In accordance with another aspect of the present invention, there is provided

### BRIEF DESCRIPTION OF THE DRAWINGS

The above and other objects and features of the present invention will become apparent from the following description of preferred embodiments given in conjunction with the accompanying drawings, in which:

FIG. 1A shows a block diagram illustrating an interaction among participants of a blind signature system in accordance with the present invention;

FIG. 1B is a block diagram illustrating a process for generating and verifying a blind signature in accordance with the present invention; and

FIG. 2 describes a flow chart showing an operation of the system for generating and verifying an ID-based blind signature by using bilinear parings in accordance with a preferred embodiment of the present invention.

### DETAILED DESCRIPTION OF THE PREFERRED EMBODIMENTS

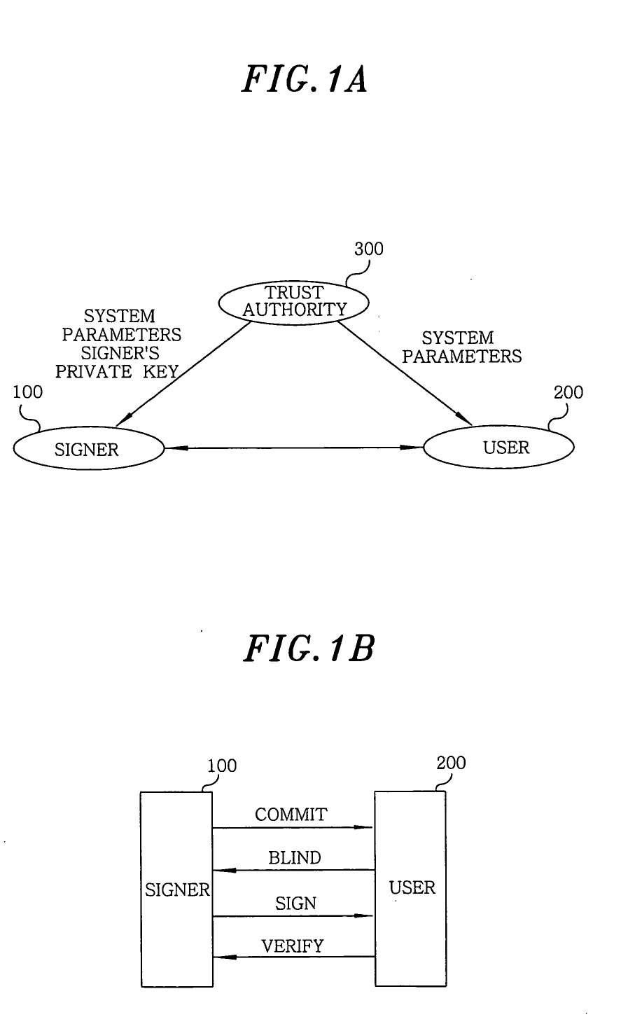

FIG. 1A illustrates an interaction among participants of a blind signature system in accordance with the present invention. The system includes three participants, i.e., a signer 100, a user 200 and a trust authority 300. Herein, each of participants of the system may be a computer system and may communicate with another remotely by using any kind of communications network or other techniques. The information to be transferred between the participants may be stored and/or held in various types of storage media.

The trust authority 300 generates system parameters and selects a master key. Further, the trust authority 300 generates a private key by using the signer's identity and the master key. Then, the trust authority 300 discloses or publishes the system parameters and transfers the private key to the signer 100 through a secure channel.

The user 200 receives the system parameters which the trust authority 300 provides. Then, the user 200 stores or holds them in a storage media.

Meanwhile, the signer 100 receives the system parameters and the private key which the trust authority 300 provides. Then, the signer 100 stores or holds them in a storage media.

Referring to FIG. 1B, a process for generating and verifying a blind signature between the signer 100 and the user 200 is shown. The signer 100 computes a commitment by using at least one of the system parameters and sends the commitment to the user 200. Thereafter, the user 200 blinds a message to be signed by using the commitment and a public key, which is generated by using the signer's identity, and sends the blinded message to the signer 100. Then, the signer 100 computes a signed value of the message by using the private key and sends it back to the user 200 without knowing the contents of the message. Finally, the user 200 receives the signed message from the signer 100 and verifies the signature.

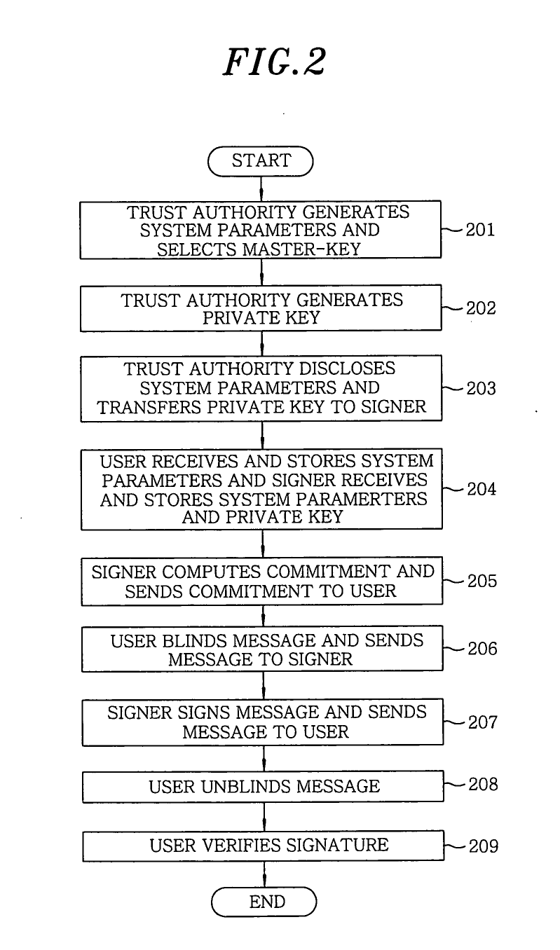

Referring now to FIG. 2, a detailed description on a method for generating and verifying an ID-based blind signature by using bilinear parings in accordance with a preferred embodiment of the present invention will be presented.

Let G₁ be a cyclic additive group generated by P, whose order is a prime q, and G₂ be a cyclic multiplicative group of the same order q. Discrete logarithm problems in both G₁ and G₂ are considered to be hard. Let e: G₁×G₁→G₂ be a pairing that satisfies following conditions:
1. Bilinear: e(aP, bQ)=e(P, Q)^{ab};
2. Non-degenerate: There exists P, Q ∈ G₁ such that e(P, Q) ≈ 1; and
3. Computability: There is an efficient algorithm to compute e(P, Q) for all P, Q ∈ G₁.

During a process of generating system parameters and selecting master key (step 201), which is performed by the trust authority 300, the cyclic groups G₁ and G₂, order of each of them being q, are generated. Then P (the generator of G₁) and e: G₁×G₁→G₂ (a pairing of the two cyclic group G₁ and G₂) are generated. In the present invention, G₁ is an elliptic curve group or hyperelliptic curve Jacobians and G₂ uses cyclic multiplicative group Z_{q}^{*}. Then, the trust authority 300 selects an integer s belonging to Z_{q}^{*} as a master key and computes P_{pub}=s·P. Additionally, the trust authority 300 selects hash functions H₁: {0,1}^{*}→Z_{q}^{*} and H₂: {0,1}^{*}→G₁.

Thereafter, the trust authority 300 generates a private key by using the signer's identity and the master key (step 202). Given the signer's identity ID, which implies the public key Q_{ID}=H₂(ID), the trust authority 300 returns the private key S_{ID}=s·Q_{ID}.

The trust authority 300 discloses or publishes the system parameters. More precisely, the trust authority 300 publishes <G₁, G₂, e, q, P, P_{pub}, H₁ and H₂> as the system parameters that the signer 100 and the user 200 may share. Further, the trust authority 300 transfers the private key to the signer 100 through a secure channel (step 203).

The user 200 receives and stores the system parameters while the signer 100 receives and stores the system parameters and the private key (step 204).

During a process of the blind signature, the signer 100 randomly chooses a number r ∈ Z_{q}^{*}, computes U=r·Q_{ID}, and sends U to the user 200 as a commitment (step 205).

Thereafter, the user 200 randomly chooses α, β∈ Z_{q}^{*} as blinding factors. The user 200 computes a blinded message h described by h=α⁻¹H₁(m, U′)+β and U′=αU+αβQ_{ID}, where m is a message to be signed. Then the user 200 sends h to the signer 100 (step 206).

Thereafter, the signer 100 sends back a signed message V described by V=(r+h)S_{ID}(step 207).

Thereafter, the user 200 computes V′=αV by using the blinding factors the user 200 chose, and outputs (m, U′, V′) (step 208). Then, (U′, V′) is the blind signature of the message m.

During a process of verification (step 209), the user 200 makes use of the message m, the system parameters and the signer's public key Q_{ID}. The signature is acceptable if and only if e(V′, P)=e(U′+H₁(m, U′)Q_{ID}, P_{pub}). The verification of the signature is justified by employing the following equations:

$$\begin{matrix}e ( {V}^{′} , P ) = e ( α V , P ) \\ = e ( ( α r + α h ) {S}_{ID} , P ) \\ = e ( ( α r + {H}_{1} ( m , {U}^{′} ) + αβ ) {Q}_{ID} , {P}_{pub} ) \\ = e ( ( α r + αβ ) {Q}_{ID} + {H}_{1} ( m , {U}^{′} ) {Q}_{ID} , {P}_{pub} ) \\ = e ( {U}^{′} , + {H}_{1} ( m , {U}^{′} ) {Q}_{ID} , {P}_{pub} ) .\end{matrix}$$

As describe above, the ID-based blind signature scheme of the present invention is considered as a combination of a general blind signature scheme and an ID-based one. In other words, it is a kind of blind signature but its public key for verification is just the signer's identity.

The ID-based blind signature scheme can be performed with supersingular elliptic curves or hyperelliptic curves. The essential operation in the ID-based signature schemes is to compute a bilinear pairing. The computation of a bilinear pairing may be performed efficiently and the length of a signature can be reduced by using compression techniques.

Since the scheme of the present invention is based on an identity rather than an arbitrary number, a public key includes one's information, e.g., an email address, that may uniquely identify oneself. In some applications, the lengths of public keys and signatures can be reduced. For instance, in an electronic voting or an electronic auction system, the registration manager (RM) can play the role of the trust authority. In the registration phase, RM gives a bidder or a voter his registration number as his public key={(The name of the e-voting or e-auction system ∥ RM ∥ Date ∥ Number), n}. Here, n is the number of all bidders or voters.

Further, the blind signature of the present invention provides the user's anonymity and non-forgeability. Let Pa be the pairing operation, Pm the point scalar multiplication on G₁, Ad the point addition on G₁, Mu the multiplication in Z_{q}, Div the division in Z_{q} and MuG2 the multiplication in G₂. In a process of issuing blind signature, the user is only required to compute 3Pm+1Ad+1Mu+1Div, while the signer is required 2Pm. And in a process of verification, the computation of 2Pa+1Pm+1Ad is needed. It should be noted that the pairing operation is the most time-consuming computation. Since, in the blind signature issuing protocol of the present invention, the user need not compute the pairing, the computation of present invention is very efficient.

The efficiency of the blind signature system is of paramount importance when the number of verifications is considerably large, e.g., when a bank issues a large number of electronic coins and a customer wishes to verify the correctness of the coins. Assuming that (U1′, V1′), (U2′, V2′), . . . , (Un′, Vn′) are ID-based blind signatures on messages m1, m2, . . . , mn which issued by the signer with identity ID. The batch verification is then to test if the following equation satisfies:

$$e ( {\sum }_{i = 1}^{n} {V}_{i}^{′} , P ) = e ( {\sum }_{i = 1}^{n} {U}_{i}^{′} + ( {\sum }_{i = 1}^{n} {H}_{1} ( {m}_{i} , {U}_{i}^{′} ) ) {Q}_{ID} , {P}_{pub} ) .$$

If the user verifies these signatures one by one, then the computation of 2nPa+nPm+nAd is needed, but if the user uses the batch verification, 2 Pa+1Pm+3(n−1)Ad is only required. Furthermore, the security against the generic parallel attack doesn't depend on the difficulty of ROS problem.

The above-described system for generating and verifying an ID-based blind signature by using bilinear parings in accordance with the present invention may reduce the amount of computing time and storage and simplify the key management procedures because processes needed in the certificate-based public key setting, i.e., transmission of certificates, verification of certificates and the like, are not needed.

While the invention has been shown and described with respect to the preferred embodiments, it will be understood by those skilled in the art that various changes and modifications may be made without departing from the spirit and scope of the invention as defined in the following claims.

1. A method for generating and verifying an ID-based blind signature by using bilinear parings, the method comprising the steps of:
generating system parameters, selecting a master key, and then disclosing the system parameters by a trust authority;
generating a private key by using a signer's identity and the master key, and then transferring the private key to the signer through a secure channel by the trust authority;
receiving and storing the system parameters by a user and receiving and storing the system parameters and the private key by the signer;
computing a commitment by using at least one of the system parameters, and then sending the commitment to the user by the signer;
blinding a message by using the commitment and a public key based on the signer's identity, and then sending the blinded message to the signer by the user;
signing the blinded message by using the private key, and then sending the signed message to the user by the signer;
unblinding the signed message by the user; and
verifying the signature by the user,
wherein the system parameters include G₁, G₂, e, q, P, P_{pub}, H₁ and H₂, where G₁ is a cyclic additive group whose order is a prime q, G₂ is a cyclic multiplicative group of the same order q, e is a bilinear paring defined by e: G₁×G₁→G₂, P is a generator of G₁, P_{pub} is the trust authority's public key described by P_{pub}=s·P, where s is the master key, and H₁ and H₂ are hash functions, respectively, described by H₁: {0,1}^{*}→Z_{q}^{*} and H₂: {0,1}^{*}→G₁, where Z_{q}^{*} is a cyclic multiplicative group,
wherein the public key Q_{ID} is described by Q_{ID}=H₂(ID), where ID is the signer's identity, and the private key S_{ID} is described by S_{ID}=s·Q_{ID}, and
wherein the commitment U is described by U=r·Q_{ID}, where r is a random number the signer chooses.

2. The method of claim 1, wherein the blinded message h is described by h=α⁻¹H₁(m, U′)+β, where m is a message to be sent, U′ is described by U′=αU+αβQ_{ID} and α and β are blinding factors belonging to Z_{q}^{*}.

3. The method of claim 2, wherein the signed message is described by V=(r+h) S_{ID}.

4. The method of claim 3, wherein the step of unblinding is performed by using formula V′=αV.

5. The method of claim 4, wherein the step of verifying is preformed by using following equations:
e(V′,P)
=e(U′, +H₁(m,U′)Q_{ID},P_{pub}).

6. An apparatus for generating and verifying an ID-based blind signature by using bilinear parings, the apparatus comprising:
means for generating system parameters, selecting a master key, and then disclosing the system parameters by a trust authority;
means for generating a private key by using a signer's identity and the master key, and then transferring the private key to the signer through a secure channel by the trust authority;
means for receiving and storing the system parameters by a user and receiving and storing the system parameters and the private key by the signer;
means for computing a commitment by using at least one of the system parameters, and then sending the commitment to the user by the signer;
means for blinding a message by using the commitment and a public key based on the signer's identity, and then sending the blinded message to the signer by the user;
means for signing the blinded message by using the private key, and then sending the signed message to the user by the signer;
means for unblinding the signed message by the user; and
means for verifying the signature by the user,
wherein the system parameters include G₁, G₂, e, q, P, P_{pub}, H₁ and H₂, where G₁ is a cyclic additive group whose order is a prime q, G₂ is a cyclic multiplicative group of the same order q, e is a bilinear paring defined by e: G₁×G₁→G₂, P is a generator of G₁, P_{pub} is the trust authority's public key described by P_{pub}=s·P, where s is the master key, and H₁ and H₂ are hash functions, respectively, described by H₁: {0,1}^{*}→Z_{q}^{*} and H₂: {0,1}^{*}→G₁, where Z_{q}^{*} is a cyclic multiplicative group,
wherein the public key Q_{ID} is described by Q_{ID}=H₂(ID), where ID is the signer's identity, and the private key S_{ID} is described by S_{ID}=s·Q_{ID}, and
wherein the commitment U is described by U=r·Q_{ID}, where r is a random number the signer chooses.

7. The apparatus of claim 6, wherein the blinded message h is described by h=α⁻¹H₁(m, U′)+β, where m is a message to be sent, U′ is described by U′=αU+αβQ_{ID} and α and β are blinding factors belonging to Z_{q}^{*}.

8. The apparatus of claim 7, wherein the signed message is described by V=(r+h) S_{ID}.

9. The apparatus of claim 8, wherein the means for unblinding is performed by using formula V′=αV.

10. The apparatus of claim 9, wherein the means for verifying is preformed by using following equations:
e(V′,P)
=e(U′, +H₁(m,U′)Q_{ID},P_{pub}).
